(19) United States
(12) Patent Application Publication
(10) Pub. No.: US 2023/0358162 A1
(43) Pub. Date: Nov. 9, 2023

(54) APPARATUS OF INJECTING FUEL FOR ENGINE AND METHOD THEREOF

(71) Applicants: Hyundai Motor Company, Seoul (KR); Kia Corporation, Seoul (KR)

(72) Inventors: Jonghyeok Lee, Hwaseong (KR); Dong Hee Han, Seongnam (KR); Hyunjin Kang, Hwaseong (KR); Seungwoo Hong, Seoul (KR); Kwanhee Lee, Suwon (KR); Jaeheun Kim, Pyeongtaek (KR); Ingee Suh, Yongin (KR); Heechang Oh, Seongnam (KR)

(21) Appl. No.: 18/076,162

(22) Filed: Dec. 6, 2022

(30) Foreign Application Priority Data
May 9, 2022 (KR) 10-2022-0056836

(51) Int. Cl. F02B 23/10; F02B 75/12

(52) U.S. Cl. CPC F02B 23/10; F02B 75/12; F02B 2075/125; F02B 2023/106

(57) ABSTRACT

Disclosed are an apparatus of injecting fuel for an engine and a method thereof.

The apparatus of injecting fuel for an engine includes: a main injector positioned adjacent to an exhaust valve and injecting the fuel into a combustion chamber of the engine; and an auxiliary injector positioned adjacent to an intake valve and injecting the fuel into the combustion chamber of the engine later than injection time of the main injector, wherein the fuel injected from the main injector and the fuel injected from the auxiliary injector are injected into the combustion chamber in a tumble direction.

### CROSS-REFERENCE TO RELATED APPLICATION

This application claims under 35 U.S.C. § 119(a) the benefit of Korean Patent Application No. 10-2022-0056836 filed in the Korean Intellectual Property Office on May 9, 2022, the entire contents of which are incorporated herein by reference.

### BACKGROUND OF THE DISCLOSURE

### Technical Field

The present disclosure relates to an apparatus of injecting fuel for an engine and a method thereof, and more particularly, to an apparatus of injecting fuel for an engine, in which fuel is injected into a combustion chamber of a gasoline engine through two injectors, and a method thereof.

### Background

A gasoline engine uses diluted combustion to control rapid reaction of a mixture of air and fuel in a combustion process, to reduce a heat transfer loss by lowering a combustion temperature, and to reduce a pumping loss in intake and exhaust processes.

Methods for implementing the diluted combustion may include diluted combustion using exhaust gas (e.g., exhaust gas recirculation (EGR)), diluted combustion using air (e.g., lean combustion), diluted combustion supplying a non-reactive fluid such as water, or the like.

In case of the gasoline engine, a flame core may be formed through ignition in an initial combustion process, grow in a form of flame propagation with laminar flame speed, and develop into the flame propagation with turbulence flame speed.

The flame core may be required to have an initial size which is a certain size or more to stably grow in the initial combustion process.

An initial size of the flame core may be increased as a flame speed of the laminar flame is increased.

However, the laminar flame speed may be low in a high diluted combustion mode, and the initial combustion process may thus be easily delayed or fail, which may cause combustion instability.

Therefore, required is a technique for increasing the initial size of the flame core to implement stable diluted combustion.

The above information disclosed in this Background section is only for enhancement of understanding of the background of the disclosure, and therefore it may contain information that does not form the preexisting technology that is already known in this country to a person of ordinary skill in the art.

### SUMMARY OF THE DISCLOSURE

Embodiments of the present disclosure provide an apparatus of injecting fuel for an engine, in which combustion stability is secured in a diluted combustion mode by maintaining an initial size of a flame core large in a gasoline engine, and a method thereof.

According to an exemplary embodiment of the present disclosure, an apparatus of injecting fuel for an engine includes: a main injector positioned adjacent to an exhaust valve and injecting the fuel into a combustion chamber of the engine; and an auxiliary injector positioned adjacent to an intake valve and injecting the fuel into the combustion chamber of the engine later than injection time of the main injector, wherein the fuel injected from the main injector and the fuel injected from the auxiliary injector are injected into the combustion chamber in a tumble direction.

The fuel injected from the main injector may be injected within an angle range set based on a side surface of the combustion chamber.

The fuel injected from the main injector may be injected within the range of about zero to about 40 degrees based on the side surface of the combustion chamber.

The fuel injected from the auxiliary injector may be injected within an angle range set based on a plane perpendicular to the side surface of the combustion chamber. The fuel injected from the auxiliary injector may be injected within the range of about zero to about 15 degrees based on the plane perpendicular to the side surface of the combustion chamber.

The fuel injected from the main injector may be injected during an intake stroke.

The fuel injected from the auxiliary injector may be injected during a compression stroke.

An amount of the fuel injected from the main injector may be set to be greater than an amount of the fuel injected from the auxiliary injector.

In some embodiments, an exhaust port through which exhaust gas is emitted is connected to the combustion chamber, and the exhaust valve is installed in the exhaust port, and an intake port through which intake air introduced from the outside flows is connected to the combustion chamber, and the intake valve is installed in the intake port.

In some embodiments, an igniter is mounted between the intake port and the exhaust port and ignites a mixture of air and fuel introduced into the combustion chamber through the intake port by using spark discharge.

In some embodiments, the auxiliary injector injects the fuel toward the igniter.

In some embodiments, the main injector injects the fuel toward a bottom of the combustion chamber.

In some embodiments, the combustion chamber comprises a piston reciprocating therein.

According to another embodiment of the present disclosure, a method of injecting fuel for an engine includes: determining, by a controller, whether the engine is operated in a diluted combustion mode or a theoretical air-fuel ratio mode; injecting, by control of the controller, the fuel into a combustion chamber through a main injector in a tumble direction during an intake stroke when the engine is operated in the diluted combustion mode; and injecting, by the control of the controller, the fuel into the combustion chamber through an auxiliary injector in the tumble direction during a compression stroke.

The fuel injected from the main injector may be injected within an angle range set based on a side surface of the combustion chamber.

The fuel injected from the main injector may be injected within the range of about zero to about 40 degrees based on the side surface of the combustion chamber.

The fuel injected from the auxiliary injector may be injected within an angle range set based on a plane perpendicular to the side surface of the combustion chamber.

The fuel injected from the auxiliary injector may be injected within the range of about zero to about 15 degrees based on the plane perpendicular to the side surface of the combustion chamber.

An amount of the fuel injected from the main injector may be set to be greater than an amount of the fuel injected from the auxiliary injector.

According to the apparatus of injecting fuel for an engine and the method thereof according to the embodiments of the present disclosure as described above, the flow in the tumble direction around the igniter may be enhanced by injecting the fuel through the main and auxiliary injectors in the tumble direction in which the mixture flows when the engine is operated in the diluted combustion mode.

Furthermore, the flow of the mixture in the tumble direction may be enhanced while the fuel injected from the auxiliary injector does not interfere with the intake valve or the exhaust valve by performing the after-injection during the compression stroke in which both the intake valve and the exhaust valve are closed.

In another embodiment, vehicles are provided that comprise an apparatus as disclosed herein.

### BRIEF DESCRIPTION OF THE DRAWINGS

The drawings are for reference only to describe embodiments of the present disclosure, and thus the spirit of the present disclosure should not be construed as being limited to the accompanying drawings.

FIG. 1 is a conceptual diagram showing a configuration of an apparatus of injecting fuel for an engine according to an exemplary embodiment of the present disclosure.

FIG. 2 is a block diagram showing the configuration of the apparatus of injecting fuel for an engine according to an exemplary embodiment of the present disclosure.

FIG. 3 is a diagram for explaining a main injection process according to an exemplary embodiment of the present disclosure.

FIG. 4 is a diagram for explaining an auxiliary injection process according to an exemplary embodiment of the present disclosure.

FIG. 5 is a flowchart showing a method of injecting fuel for an engine according to another embodiment of the present disclosure.

FIG. 6 is a graph for explaining a process of injecting fuel for an engine according to another embodiment of the present disclosure.

### DETAILED DESCRIPTION OF THE EMBODIMENTS

Hereinafter, embodiments of the present disclosure will be described in detail with reference to the accompanying drawings so that those skilled in the art to which the present disclosure pertains may easily practice the present disclosure.

However, the present disclosure may be modified in various different forms, and is not limited to the embodiments provided in the present specification.

A portion unrelated to the description is omitted to obviously describe the present disclosure, and the same or similar components are denoted by the same reference numeral throughout the specification.

In addition, the size and thickness of each component shown in the accompanying drawings are arbitrarily shown for convenience of explanation. Therefore, the present disclosure is not necessarily limited to contents shown in the accompanying drawings, and the thicknesses are exaggerated in the drawings to clearly represent several portions and regions.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, an apparatus of injecting fuel for an engine according to an exemplary embodiment of the present disclosure is described in detail with reference to the accompanying drawings.

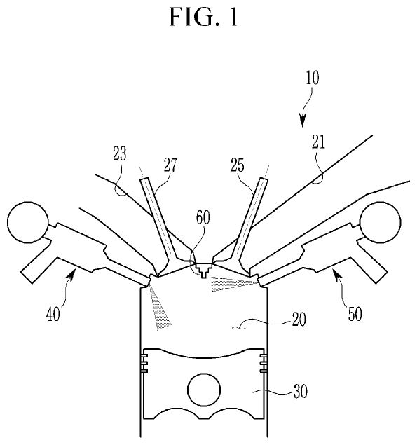

FIG. 1 is a conceptual diagram showing a configuration of the apparatus of injecting fuel for an engine according to an exemplary embodiment of the present disclosure.

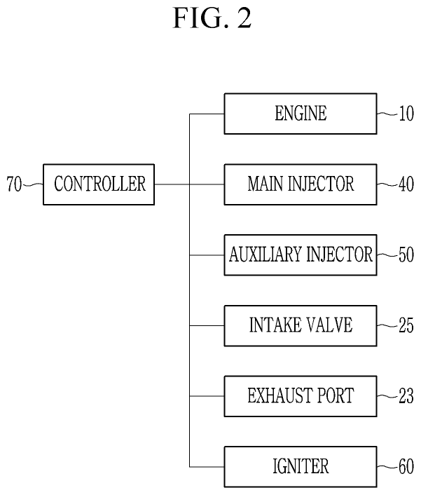

In addition, FIG. 2 is a block diagram showing the configuration of the apparatus of injecting fuel for an engine according to an exemplary embodiment of the present disclosure.

As shown in FIGS. 1 and 2, the apparatus of injecting fuel for an engine according to an exemplary embodiment of the present disclosure may include a piston reciprocating in a combustion chamber 20 of an engine 10, a main injector 40 and an auxiliary injector 50 for injecting the fuel into the combustion chamber 20, and a controller 70 for controlling operations of the main injector 40 and the auxiliary injector 50.

An intake port 21 through which intake air introduced from the outside flows may be connected to the combustion chamber 20, and an intake valve 25 may be installed in the intake port 21.

The intake port 21 and the combustion chamber 20 may be fluidly connected or blocked based on the opening or closing of the intake valve 25.

That is, the intake valve 25 may selectively open and close between the intake port 21 and the combustion chamber 20.

In addition, an exhaust port 23 through which exhaust gas is emitted may be connected to the combustion chamber 20, and an exhaust valve 27 may be installed in the exhaust port 23.

The exhaust port 23 and the combustion chamber 20 may be fluidly connected or blocked based on the opening or closing of the exhaust valve 27.

That is, the exhaust valve 27 may selectively open and close between the exhaust port 23 and the combustion chamber 20.

The pair of intake and exhaust valves 25 and 27 may be disposed to face each other.

An igniter 60 (or spark plug) may be mounted between the intake port 21 and the exhaust port 23 (or at an upper center of the combustion chamber 20).

The igniter 60 may ignite a mixture of air and fuel introduced into the combustion chamber 20 through the intake port 21 by using spark discharge.

The main injector 40 may be installed adjacent to the exhaust port 23, and may be a gasoline direct injection (GDI) type injector directly injecting the fuel into the combustion chamber 20.

The main injector 40 may inject all necessary fuel when the engine is operated in a theoretical air-fuel ratio mode (λ=1) rather than in a diluted combustion mode (λ>1), and inject only some of all the necessary fuel in the diluted combustion mode.

The main injector 40 may inject the fuel during an intake stroke in the diluted combustion mode. For example, the main injector 40 may inject most of the fuel (e.g., about 95% of a total amount of the fuel) at a crank angle (CA) of 360 to 180 degrees from a before top dead center (BTDC).

The main injector 40 may inject the fuel into the combustion chamber 20 in a tumble direction in which the mixture of air and fuel flows.

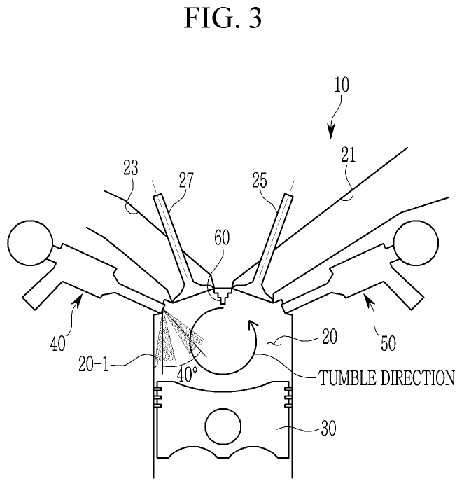

To this end, the fuel injected from the main injector 40 may be injected within an angle range set based on a side surface 20-1 of the combustion chamber 20. The set angle may be within the range of about zero to about 40 degrees based on the side surface of the combustion chamber 20 (see FIG. 3).

As such, the main injector 40 may inject the fuel into the combustion chamber in the tumble direction in which the mixture flows, thereby enhancing the flow of the mixture in the tumble direction.

The auxiliary injector 50 may be installed adjacent to the intake port 21, and may be a gasoline direct injection (GDI) type injector directly injecting the fuel into the combustion chamber 20.

The auxiliary injector 50 may inject the fuel during a compression stroke later than an injection time of the main injector 40 in the diluted combustion mode.

For example, the auxiliary injector 50 may inject some fuel (e.g., 5%) of the total fuel to be injected into the combustion chamber 20 at a crank angle (CA) of 180 degrees from the BTDC at an ignition time.

That is, the injection of the fuel through the auxiliary injector 50 may be performed by injecting only a minimum amount of the fuel to reduce exhaust emissions.

The auxiliary injector 50 may inject the fuel into the combustion chamber 20 in the tumble direction in which the mixture flows.

In other words, the auxiliary injector 50 may inject the fuel toward the igniter 60.

To this end, the fuel injected from the auxiliary injector 50 may be injected within an angle range set based on a plane 20-2 perpendicular to the side surface of the combustion chamber 20.

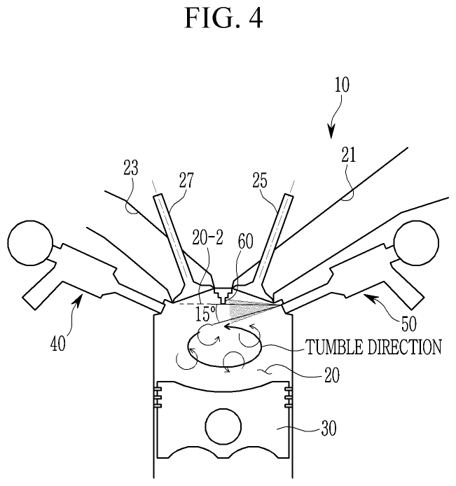

The set angle may be within the range of about zero to about 15 degrees based on the plane perpendicular to the side surface of the combustion chamber 20 (see FIG. 4).

In this way, the auxiliary injector 50 may inject the fuel into the combustion chamber 20 in the tumble direction in which the mixture flows (or inject the fuel toward the igniter), thereby further enhancing the flow of the mixture weaken during the compression stroke.

In addition, the auxiliary injector 50 may inject the fuel during the compression stroke in which both the intake valve 25 and the exhaust valve 27 are closed to prevent interference caused by collision of the fuel injected from the auxiliary injector 50 with the intake and exhaust valves 25 and 27 in advance, thereby enhancing the flow of the mixture in the tumble direction, around the igniter 60.

In addition, the auxiliary injector 50 may inject the fuel toward the igniter 60 during the compression stroke to increase a size of a flame core generated in the igniter 60 in the flow direction (e.g., tumble direction) of the mixture, thereby improving ignitability of the mixture.

The controller 70 may control injection (e.g., injection time, and/or injection amount) of the fuel injected from the main and auxiliary injectors 40 and 50.

To this end, the controller 70 may be at least one processor operated according to a set program, and the set program may perform each step of a method of injecting fuel for an engine according to another embodiment of the present disclosure.

Hereinafter, an operation of the apparatus of injecting fuel for an engine according to an exemplary embodiment of the present disclosure as described above is described in detail with reference to the accompanying drawings.

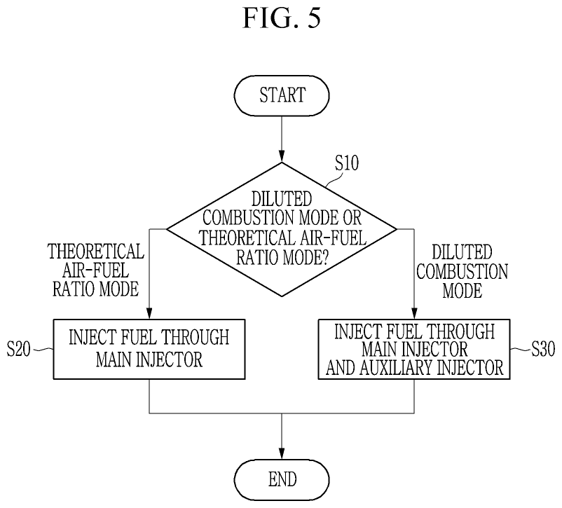

FIG. 5 is a flowchart showing the method of injecting fuel for an engine according to another embodiment of the present disclosure.

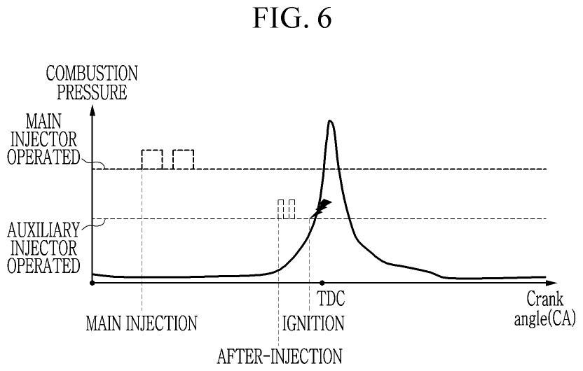

In addition, FIG. 6 is a graph for explaining a process of injecting fuel for an engine according to another embodiment of the present disclosure.

Referring to FIG. 5, a controller 70 may determine whether the engine is operated in a diluted combustion mode or a theoretical air-fuel ratio mode (S10).

For example, an operation region of the engine may be divided into an optimum operating point region and a region other than the optimum operating point region.

Here, the engine may be operated in the diluted combustion mode (λ>1) in the optimum operating point region, and the engine 10 may be operated in the theoretical air-fuel ratio mode (λ=1) in the region other than the optimum operating point region.

When the engine is operated in the theoretical air-fuel ratio mode, the controller 70 may allow the fuel to be injected into a combustion chamber 20 only through a main injector 40, and here, the fuel may be injected during an intake stroke (i.e., at a crank angle (CA) of 360 to 180 degrees from a before top dead center (BTDC)) (S20). When the engine is operated in the diluted combustion mode, the controller 70 may allow the fuel to be injected through the main injector 40 and an auxiliary injector 50 (S30).

Here, the fuel injection through the main injector 40 may be performed during an intake stroke, and the fuel injection through the auxiliary injector 50 may be performed during a compression stroke.

Most of the fuel (about 95%) required for combustion may be injected (or main injection may be performed) through the main injector 40, and the remaining fuel (about 5%) may be injected (or after-injection may be performed) through the auxiliary injector 50 (see FIG. 6).

Here, the main injector 40 positioned adjacent to the exhaust port 23 may inject the fuel into the combustion chamber 20 in a tumble direction in which a mixture flows (see FIG. 3).

In other words, the main injector 40 may inject the fuel toward the bottom of the combustion chamber 20.

In this way, the flow of the mixture in the tumble direction generated inside the combustion chamber 20 may be enhanced by the main injection performed during the intake stroke.

In addition, the auxiliary injector 50 positioned adjacent to an intake port 21 may inject the fuel into the combustion chamber 20 in the tumble direction in which the mixture flows (see FIG. 4).

In other words, the auxiliary injector 50 may inject the fuel from the intake port 21 to a left side of the combustion chamber 20.

In other words, the auxiliary injector 50 may inject the fuel toward an igniter 60.

In this way, the flow in the tumble direction around the igniter 60 may be enhanced by performing the after-injection through the auxiliary injector 50 during the compression stroke.

In addition, the flow of the mixture in the tumble direction may be enhanced while the fuel injected from the auxiliary injector 50 does not interfere with the intake valve 25 or the exhaust valve 27 by performing the after-injection during the compression stroke in which both an intake valve 25 and an exhaust valve 27 are closed.

While the present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: engine
20: combustion chamber
21: intake port
23: exhaust port
25: intake valve
27: exhaust valve
30: piston
40: main injector
50: auxiliary injector
60: igniter
70: controller

What is claimed is:

1. An apparatus of injecting fuel for an engine, the apparatus comprising:
a main injector positioned adjacent to an exhaust valve and injecting fuel into a combustion chamber of the engine; and
an auxiliary injector positioned adjacent to an intake valve and injecting the fuel into the combustion chamber of the engine later than injection time of the main injector,
wherein the fuel injected from the main injector and the fuel injected from the auxiliary injector are injected into the combustion chamber in a tumble direction.

2. The apparatus of claim 1, wherein the fuel injected from the main injector is injected within an angle range set based on a side surface of the combustion chamber.

3. The apparatus of claim 2, wherein the fuel injected from the main injector is injected within the range of about zero to about 40 degrees based on the side surface of the combustion chamber.

4. The apparatus of claim 1, wherein the fuel injected from the auxiliary injector is injected within an angle range set based on a plane perpendicular to the side surface of the combustion chamber.

5. The apparatus of claim 4, wherein the fuel injected from the auxiliary injector is injected within the range of about zero to about 15 degrees based on the plane perpendicular to the side surface of the combustion chamber.

6. The apparatus of claim 1, wherein the fuel injected from the main injector is injected during an intake stroke.

7. The apparatus of claim 1, wherein the fuel injected from the auxiliary injector is injected during a compression stroke.

8. The apparatus of claim 1, wherein an amount of the fuel injected from the main injector is set to be greater than an amount of the fuel injected from the auxiliary injector.

9. The apparatus of claim 1, wherein an exhaust port through which exhaust gas is emitted is connected to the combustion chamber, and the exhaust valve is installed in the exhaust port, and an intake port through which intake air introduced from the outside flows is connected to the combustion chamber, and the intake valve is installed in the intake port.

10. The apparatus of claim 9, wherein an igniter is mounted between the intake port and the exhaust port and ignites a mixture of air and fuel introduced into the combustion chamber through the intake port by using spark discharge.

11. The apparatus claim 10, wherein the auxiliary injector injects the fuel toward the igniter.

12. The apparatus claim 1, wherein the main injector injects the fuel toward a bottom of the combustion chamber.

13. The apparatus claim 1, wherein the combustion chamber comprises a piston reciprocating therein.

14. A method of injecting fuel for an engine, the method comprising:
determining, by a controller, whether the engine is operated in a diluted combustion mode or a theoretical air-fuel ratio mode;
injecting, by control of the controller, the fuel into a combustion chamber through a main injector in a tumble direction during an intake stroke when the engine is operated in the diluted combustion mode; and
injecting, by the control of the controller, the fuel into the combustion chamber through an auxiliary injector in the tumble direction during a compression stroke.

15. The method of claim 14, wherein the fuel injected from the main injector is injected within an angle range set based on a side surface of the combustion chamber.

16. The method of claim 15, wherein the fuel injected from the main injector is injected within the range of about zero to about 40 degrees based on the side surface of the combustion chamber.

17. The method of claim 14, wherein the fuel injected from the auxiliary injector is injected within an angle range set based on a plane perpendicular to the side surface of the combustion chamber.

18. The method of claim 17, wherein the fuel injected from the auxiliary injector is injected within the range of about zero to about 15 degrees based on the plane perpendicular to the side surface of the combustion chamber.

19. The method of claim 14, wherein an amount of the fuel injected from the main injector is set to be greater than an amount of the fuel injected from the auxiliary injector.

20. A vehicle comprising the apparatus of claim 1.
